(19) United States
(12) Patent Application Publication
(10) Pub. No.: US 2009/0296912 A1
(43) Pub. Date: Dec. 3, 2009

(54) METHOD AND APPARATUS FOR FORWARDING OF FAX CALLS TO A MESSAGING SERVICE

(76) Inventors: James JACKSON, Austin, TX (US); Mehrad YASREBI, Austin, TX (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/127,187

(22) Filed: May 27, 2008

(51) Int. Cl. H04M 3/42

(52) U.S. Cl. 379/211.02

(57) ABSTRACT

A method and apparatus for forwarding of fax calls to a messaging service are disclosed. For example, the method receives a call and rings one or more endpoint devices. The method detects an off-hook condition for the one or more endpoint devices and detects a fax tone in the call. The method then informs a network to forward the call towards a messaging service.

The present invention relates generally to communication networks and, more particularly, to a method and apparatus for providing forwarding of fax calls to a messaging service in networks, e.g., Internet Protocol (IP) networks, Voice over Internet Protocol (VoIP) networks, and the like.

### BACKGROUND OF THE INVENTION

A customer may subscribe to a VoIP service with unified messaging. If a user of a legacy fax machine wishes to originate a fax towards the VoIP customer, the called party has no way to determine that the call is a fax call before answering.

### SUMMARY OF THE INVENTION

In one embodiment, the present invention discloses a method and apparatus for forwarding of fax calls to a messaging service in networks, e.g. VoIP networks. For example, the method receives a call and rings one or more endpoint devices. The method detects an off-hook condition for the one or more endpoint devices and detects a fax tone in the call. The method then informs a network to forward the call towards a messaging service.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network in accordance with one embodiment of the current invention for providing forwarding of fax calls;

FIG. 3 illustrates a flowchart of a method forwarding of fax calls to a unified messaging service;

FIG. 4 illustrates an illustrative call flow in accordance with one embodiment of the present invention; and

FIG. 5 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing an automatic forwarding of fax calls to a unified messaging service. Although the present invention is discussed below in the context of Voice over Internet Protocol (VoIP) networks, the present invention is not so limited. Namely, the present invention can be applied for other packet networks, e.g., Service over Internet Protocol (SoIP) networks, wireless networks, and the like.

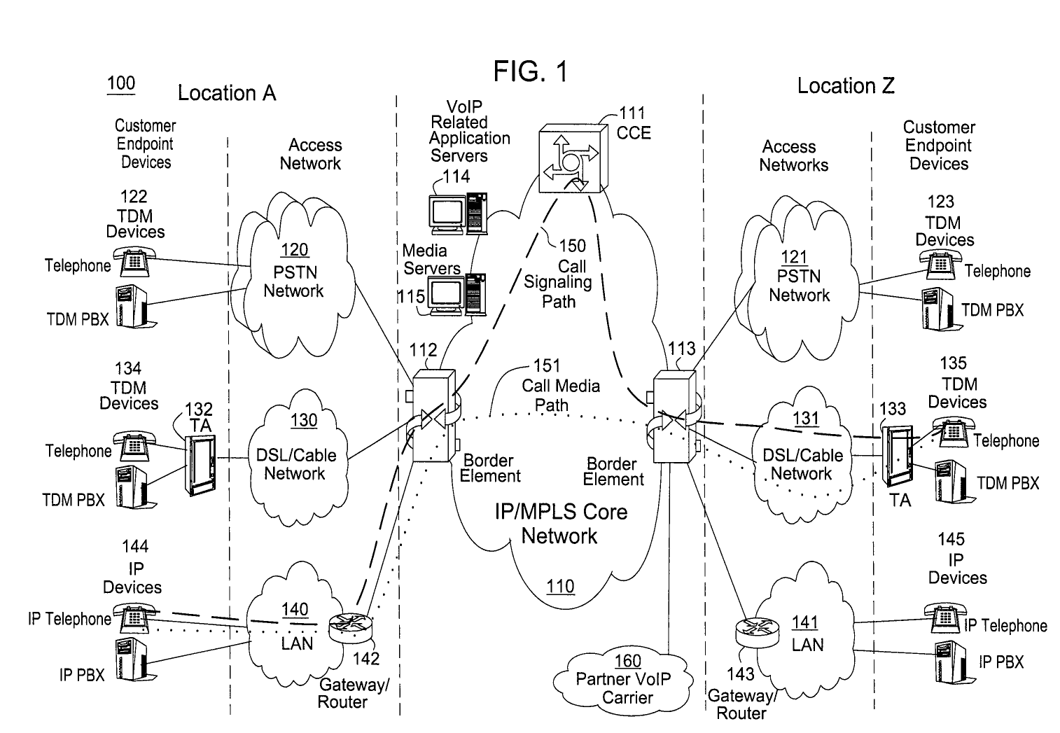

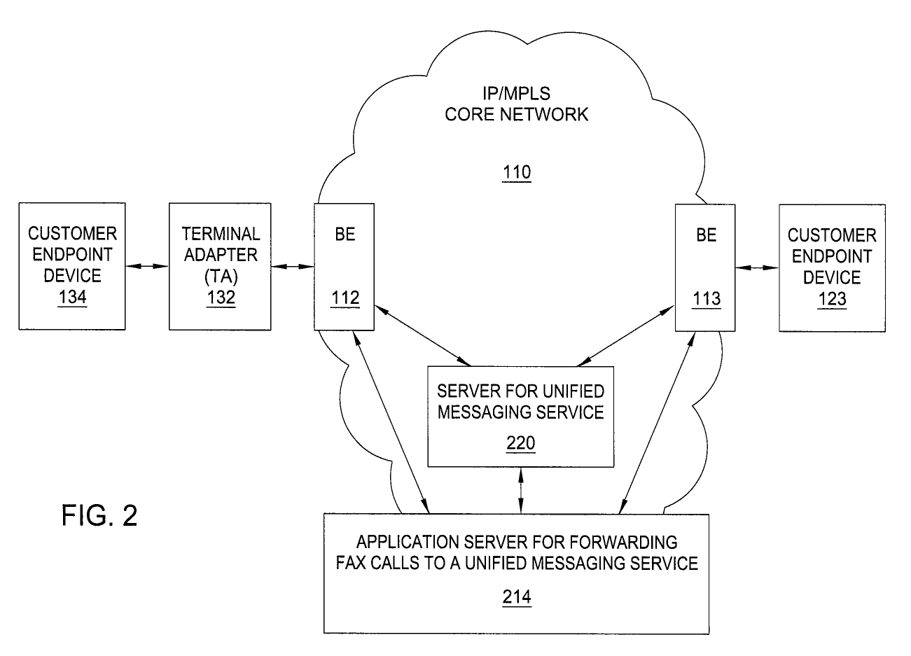

To better understand the present invention, FIG. 1 illustrates an example network 100, e.g., a packet network such as a VoIP network related to the present invention. Exemplary packet networks include Internet protocol (IP) networks, Asynchronous Transfer Mode (ATM) networks, frame-relay networks, and the like. An IP network is broadly defined as a network that uses Internet Protocol to exchange data packets. Thus, a VoIP network is considered an IP network.

In one embodiment, the VoIP network may comprise various types of customer endpoint devices connected via various types of access networks to a carrier (e.g., a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted as being limited by this particular illustrative architecture.

In one embodiment, the customer endpoint devices can be either Time Division Multiplexing (TDM) based or IP based. For example, TDM based customer endpoint devices 122, 123, 134, and 135 typically comprise of TDM phones or Private Branch Exchange (PBX). IP based customer endpoint devices 144 and 145 typically comprise IP phones or IP PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network 130, 131 via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises several VoIP components, such as the Border Elements (BEs) 112 and 113, the Call Control Element (CCE) 111, VoIP related Application Servers (AS) 114, and Media Server (MS) 115. The BE resides at the edge of the VoIP core infrastructure and interfaces with customers endpoints over various types of access networks. A BE is typically implemented as a Media Gateway and performs signaling, media control, security, and call admission control and related functions. In one embodiment, the CCE resides within the VoIP infrastructure and is connected to the BEs using the Session Initiation Protocol (SIP) over the underlying IP/MPLS based core backbone network 110. The CCE is typically implemented as a Media Gateway Controller or a softswitch and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related Application Servers (AS) in order to complete a call that requires certain service specific features, e.g., translation of an E.164 voice network address into an IP address, and so on.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112 will then send a setup signaling message, such as a SIP-INVITE message if SIP is used, to CCE 111. CCE 111 looks at the called party information and queries the necessary VoIP service related application server 114 to obtain the information to complete this call. In one embodiment, the Application Server (AS) functions as a SIP back-to-back user agent. If BE 113 needs to be involved in completing the call, CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the called party accepts the call at location Z, a call acknowledgement signaling message, such as a SIP 200 OK response message if SIP is used, is sent in the reverse direction back to the CCE 111. After the CCE 111 receives the call acknowledgement message, it will then send a call acknowledgement signaling message, such as a SIP 200 OK response message if SIP is used, toward the calling party. In addition, the CCE 111 also provides the necessary information of the call to both BE 112 and BE 113 so that the call data exchange can proceed directly between BE 112 and BE 113. The call signaling path 150 and the call media path 151 are illustratively shown in FIG. 1. Note that the call signaling path and the call media path are different. This is because, once a call has been setup between two endpoint devices, the CCE 111 does not need to be in the data path for actual direct media exchange.

It should be noted that although the present invention is disclosed in the context of Session Initiation Protocol (SIP), the present invention is not so limited. Namely, the present invention can be adapted to other signaling protocol.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

Media Servers (MS) 115 are special servers that typically handle and terminate media streams, and to provide services such as announcements, bridges, trans-coding, and Interactive Voice Response (IVR) messages for VoIP service applications. The media servers also interact with customers for media session management to accomplish tasks such as process requests.

The above IP network is described to provide an illustrative environment in which packets for voice and data services are transmitted on VoIP networks. In one embodiment, a customer may subscribe to a VoIP service with a messaging service, e.g., a unified messaging service. For example, a customer may wish incoming voice calls, fax calls, etc. to be forwarded to a messaging platform located in the service provider's network when the customer is not able to answer his/her call. For example, the customer may selectively configure the messaging service as to how incoming fax calls are to be handled, e.g., how the fax calls will be captured, formatted, stored, and/or forwarded. For example, a customer may configure the service to forward faxes to a unified messaging service and the like.

However, if a user of a legacy fax machine wishes to originate a fax towards a VoIP customer, the called party has no way to determine that the call is a fax call before answering said call. One method to enable the fax transmission is to have the caller first initiate a voice call to inform the called party that the caller is about to send a fax transmission. The called party then allows the call to be answered by the unified messaging service, i.e., the user leaves the customer endpoint device on-hook without answering the subsequent call. Another approach is having the called party hear a fax tone, and then having the called party not answer subsequent calls assuming the calling party retries the fax transmission. Both of these approaches are undesirable from a user's perspective.

In one embodiment, the current invention provides a method for automatic forwarding of fax calls to a unified messaging service. In order to clearly illustrate the teachings of the current invention, the following terminologies and networking concepts will first be described:

Calling party;

Called party;

CNG (CalliNG);

Off-hook;

On-hook; and

T.38.

Calling party refers to the person or device that originates the call. The called party refers to the person or device that receives the call. For example, if a person calls 911 for obtaining emergency service, the calling party is the person dialing 911 and the called party is the person or device answering the 911 call. CNG or CalliNG refers to the Calling facsimile (FAX) device where the CNG tones are generated by such machines when they initiate and connect a call to a called party fax device.

Off-hook refers to a condition where a handset from a base unit of a stationary phone is removed or a button on a portable phone is pressed to allow dialing by a user of the handset (or for answering an incoming call).

On-hook refers to a condition where a handset is placed in a base unit of a stationary phone or a portable phone is in a state such that incoming calls may be received (or for terminating an existing call).

T.38 refers to an International Telecommunications Union (ITU) standard for sending fax messages over IP networks in real time.

FIG. 2 illustrates an exemplary network 200 in accordance with one embodiment of the current invention for forwarding of fax calls to a unified messaging service. For example, a customer endpoint device 134 is receiving VoIP services from an IP/MPLS core network 110 via a Terminal Adaptor (TA) 132, and border element 112. The customer endpoint device 123 uses BE 113 for sending and receiving voice and data calls. The IP/MPLS core network 110 contains an application server 214 for providing forwarding of fax calls to a unified messaging service. The IP/MPLS core network 110 also contains the server for providing the unified messaging service 220. In one embodiment, the BEs 112 and 113, and the application servers 214 and 220 are interconnected to enable forwarding of fax calls to the server 220 for customers who subscribe to the service feature of forwarding of fax calls to a unified messaging service.

For example, the service provider implements a service for automatic forwarding of fax calls to a unified messaging service in an application server 214. Application server 214 may also be used to enable customers to subscribe to a unified messaging service that includes an automatic forwarding of fax calls feature. The application server 214 may then be able to determine whether or not a called party is a subscriber of the service for forwarding of fax calls.

In one embodiment, the service provider enables TA 132 to detect a fax tone when a called party answers the call. For example, the customer endpoint device 123 originates a fax towards the customer endpoint device 134. The TA 132 receives the call and rings the customer endpoint device 134. The TA then detects when a customer endpoint device 134 is off-hook. For example, the customer picks up an endpoint device such as a handset. The TA 132 then detects a fax tone originating from the calling party's device, e.g., customer endpoint device 123. For example, the called party and the TA hear the fax tone when the called party picks up the telephone. The TA 132 may then inform the application server 214 to forward the fax call towards the unified messaging service 220 on behalf of the called party. For example, the TA may send a SIP Re-INVITE message with a T.38 session descriptor directed towards the calling party's gateway. In other words, the application server may receive a message from a called party's TA, when the called party's TA detects a fax tone from a calling party. It should be noted that although the present invention is discussed in the context of using a TA to detect the fax tone and to generate a SIP Re-invite message, the present invention is not so limited. Namely, the fax tone detection can be implemented in a TA that is integrated with residential gateway or by the IP phone itself. In other words, the present invention can be adapted into other customer modules aside from the customer's TA.

It should be noted that although the present invention is disclosed in the context of using a SIP re-invite message, the present invention is not so limited. For example, the present invention can be adapted such that a SIP Notify message, and the like, is used in place of the SIP Re-invite message.

In one embodiment, the application server 214 may be implemented to instruct the TA to detect the fax tones in the call. For example, the application server 214 may detect that the call is to a called party that has subscribed to a fax forwarding service that forwards a fax call to a unified messaging service. In one embodiment, the application server 214 will insert a customer header that is sent to the TA for instructing the TA to detect a CNG (CalliNG) tones in the call. Otherwise, the TA would normally be looking for a V.21 preamble coming back from a terminating fax machine.

In one embodiment, when a SIP Re-INVITE message is received from the TA of a subscriber of a service for forwarding of fax calls, the application server originates a new SIP-INVITE message to the unified messaging service including a T.38 in the Session Description Protocol (SDP) header. For example, a new SIP-INVITE message may be sent from the application server 214 towards the server providing the unified messaging service 220. The application server 214 then receives a response from the server providing the unified messaging service 220. For example, the application server 214 receives a SIP 200 OK with a T.38 in the SDP. The application server then sends the SIP Re-INVITE towards the sender of the fax with the SDP received from the unified messaging service. The fax may then be sent to the unified messaging service.

If the leg towards the called party is not already terminated, the application server 214 terminates the leg towards the called party. For example, the called party may not have hung up upon detection of a fax tone. Alternatively, the application server 214 may connect the callee leg to a media server 115 that will play an announcement, e.g., “fax detected, call transferred to messaging platform” and the like.

In one embodiment, the TA may delay call termination when it is attempting to detect a fax tone. For example, a customer may pickup a phone, realize it is a fax call and hang-up. However, the TA may need additional time to properly detect the CNG tones. Hence, the TA may delay subsequent SIP BYE messages by a predetermined time interval to ensure that the TA has sufficient time to detect the CNG tones if the call was in fact a fax call. The length of time for delaying the call termination may be configured by a service provider and/or customer.

In one embodiment, the customer may selectively configure or provision the present fax call forwarding service. For example, a customer may use a web-portal or an IVR system to interact (e.g., providing input) with the server for unified messaging service 220 to set one or more service parameters. For example, the customer may define a time interval (e.g., between 5:00 PM to 9:00 PM each day, weekends only, a particular day of the week, a range of dates, and the like) as to when the fax forwarding service will be activated. In fact, other parameters such as a calling party ID (calling party name, calling party number and the like) can also be defined, e.g., fax calls from certain calling parties will be forwarded while other calling parties will not be forwarded and so on.

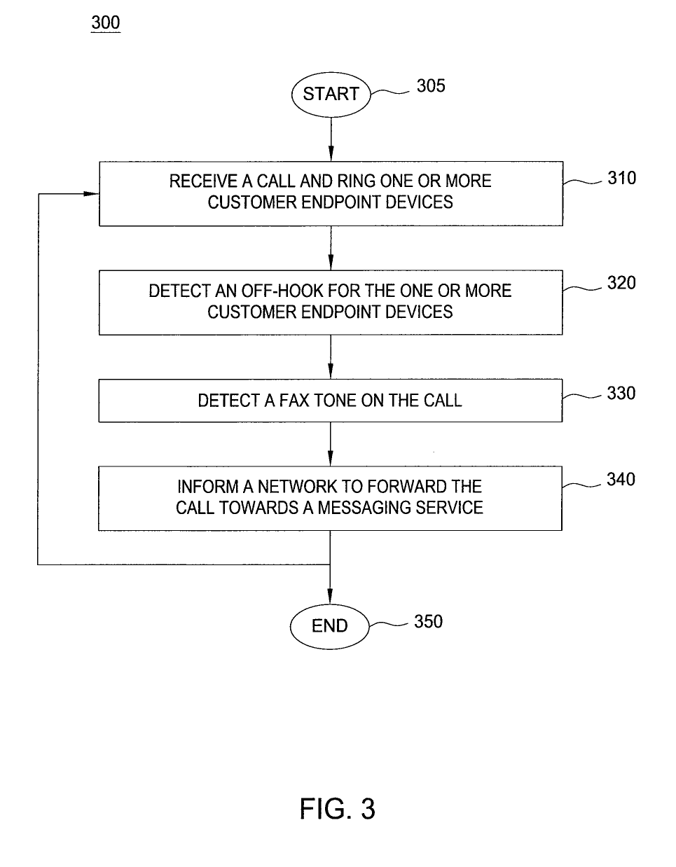

FIG. 3 illustrates a flowchart of a method 300 for providing forwarding of fax calls to a unified messaging service. For example, method 300 can be implemented by the TA 132. Method 300 starts in step 305 and proceeds to step 310.

In step 310, method 300 receives a call and rings one or more customer endpoint devices. For example, a TA receives a call and rings the customer endpoint device such as a telephone.

In step 320, method 300 detects an off-hook condition for the one or more customer endpoint devices. For example, the TA detects when an off-hook condition for a customer endpoint device when the customer picks up the customer endpoint device, e.g., a telephone hand-set.

In step 330, method 300 detects a fax tone on the call. For example, the TA detects a fax tone originating from the calling party's device. The customer may also be listening and may hang-up the phone upon hearing the fax tone. In one embodiment, the detection of the fax tone by the TA is triggered by a custom header that is received from an application server of the network service provider. In other words, the TA will only perform fax tone detection on a per call basis as instructed by a service feature application server. Alternatively, the TA can be programmed such that it will perform fax tone detection automatically without receiving specific instructions from the application server. Furthermore, in one embodiment, the TA may insert a delay if the called party (callee) hangs up the call too quickly. In other words, the TA may need additional time to properly detect the CNG tones. In such situation, the TA will insert a delay before sending a SIP Bye message.

In step 340, method 300 informs the service provider to forward the fax call towards a unified messaging service. For example, the TA may inform the application server 214 to forward the fax call towards the unified messaging service on behalf of the called party. For example, the TA may send a SIP Re-INVITE with a T.38 SDP header directed towards the calling party's gateway. Method 300 then returns to step 310 to continue receiving calls or ends in step 350.

It should be noted that although not specifically specified, one or more steps of method 300 may include a storing, displaying and/or outputting step as required for a particular application. In other words, any data, records, fields, and/or intermediate results discussed in the method can be stored, displayed and/or outputted to another device as required for a particular application. Furthermore, steps or blocks in FIG. 3 that recite a determining operation or involve a decision, do not necessarily require that both branches of the determining operation be practiced. In other words, one of the branches of the determining operation can be deemed as an optional step.

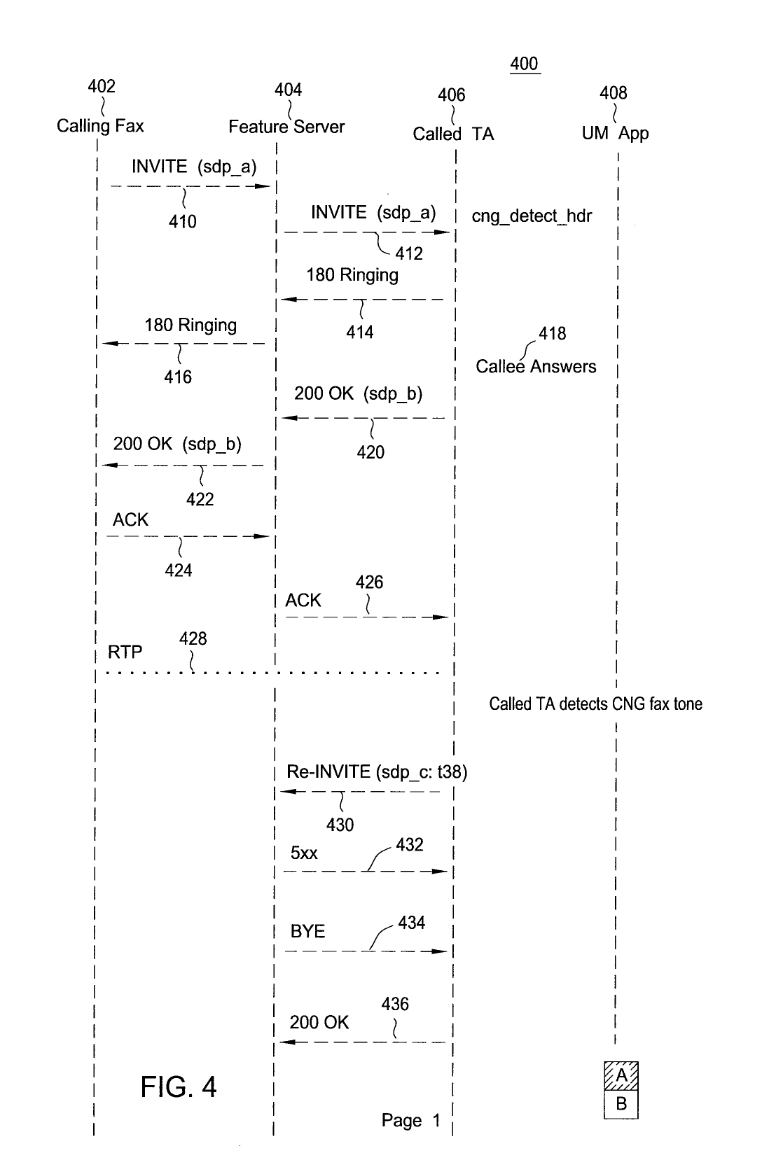

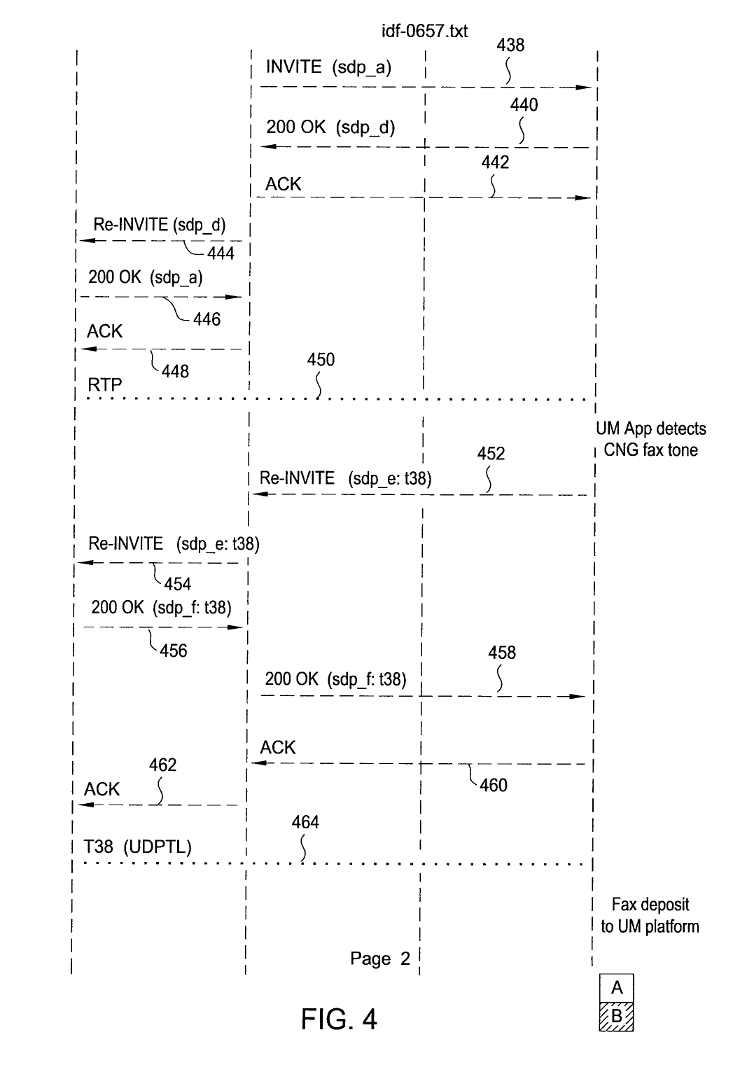

FIG. 4 illustrates an illustrative call flow 400 in accordance with one embodiment of the present invention. It should be noted that call flow 400 is only provided as an illustrative call flow in accordance with one embodiment of the present invention. Those skilled in the art will realize that the present invention can be implemented via a different call flow from that of FIG. 4 while still remaining within the scope of the present invention.

In step 410, a calling party 402, e.g., a calling fax machine of the calling party, will initiate a call, thereby generating a SIP Invite message that is sent to a feature server 404. For example, feature server 404 can be application server 214 of FIG. 2.

In step 412, the feature server 404 is made aware that the call setup message is to a subscriber that has subscribed to the current service of forwarding fax calls to a unified messaging service (i.e., to a unified messaging platform). In response, the feature server 404 forwards an Invite message to the TA 406 of the called party (also referred to as a called TA). In one embodiment, the Invite message contains a custom header that instructs the called party's TA to detect the CNG (CalliNG) tones for the call. For example, this tone, sent by a fax machine, is a distinct beep that repeats every three (3) seconds.

In step 414, the called TA 406 generates a SIP 180 ringing response that is forwarded to the feature server 404 that, in turn, forwards the SIP 180 ringing response in step 416 to the calling party's fax machine 402.

In step 418, the called TA 406 detects the called party answering the call, e.g., detecting an off-hook condition on a called party's endpoint device.

In step 420, the called TA 406 sends a 200 OK message to the feature server 404 that, in turn, forwards the 200 OK message in step 422 to the calling party's fax machine 402.

In step 424, the calling party's fax machine 402 sends an ACK message to the feature server 404 that, in turn, forwards the ACK message in step 426 to the called TA 406.

In step 428, the calling party's fax machine 402 establishes a bearer or media path (shown as a RTP path in FIG. 4) where the CNG tone sent on the media path is detected by the called TA 406.

In step 430, the called TA 406 sends a Re-invite message to the feature server 404 to indicate to the Feature Server that the caller is a FAX device. In step 432, the feature server responds with a 5xx message indicating that the feature server is not able to fulfill the request of the Re-invite message sent in step 430.

In step 434, the feature server sends a Bye message to the called TA 406. In turn, the called TA 406 responds with a 200 OK message in step 436. Namely, the call leg between the called TA 406 and the feature server 404 is terminated. However, it should be noted that the call leg between the calling party's fax machine 402 and the feature server 404 is not terminated.

In step 438, the feature server 404 sends an Invite message to the unified messaging server 408. The unified messaging server 408 responds with a 200 OK message in step 440 and the feature server 404 responds with an ACK message in step 442.

In step 444, feature server 404 sends a Re-invite message to the calling party's fax machine 402. The calling party's fax machine 402 responds with a 200 OK message in step 446 and the feature server 404 responds with an ACK message in step 448.

In step 450, the calling party's fax machine 402 again begins to send the CNG tone via a bearer or media path (shown as a RTP path in FIG. 4) that is detected by the unified messaging server 408.

In step 452, the unified messaging server 408 sends a Re-invite message to the feature server 404 requesting that the calling party's fax machine 402 uses the T.38 protocol. In turn, the feature server 404 forwards the Re-invite message to the calling party's fax machine 402 in step 454.

The calling party's fax machine 402 responds with a 200 OK message to the feature server 404 in step 456. The feature server 404 in turn forwards the 200 OK message to the unified messaging server 408.

The unified messaging server 408 responds with an ACK message to the feature server 404 in step 460. In turn, the feature server 404 forwards the ACK message to the calling party's fax machine 402 in step 462.

In step 464, the calling party's fax machine 402 sends data associated with the fax in accordance with the T.38 protocol via a bearer or media path (shown as T.38 (UDPTL) path in FIG. 4) to the unified messaging server 408. Thus, the fax is deposited onto a unified messaging platform.

In one embodiment, steps 452-464 can be perceived as optional steps. More specifically, if the feature server 404 in steps 438 and 444 had specifically indicated that the T.38 protocol to be used, then the appropriate T.38 media path would have been established in step 450, thereby removing the need to implement steps 452-464.

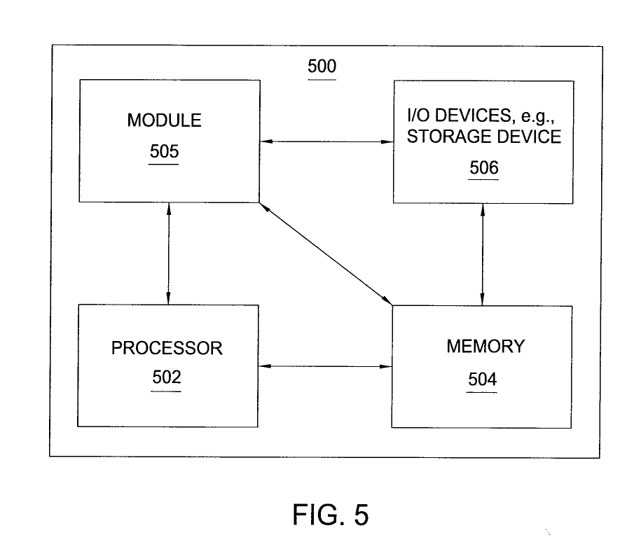

FIG. 5 depicts a high-level block diagram of a general-purpose computer suitable for use in performing the functions described herein. As depicted in FIG. 5, the system 500 comprises a processor element 502 (e.g., a CPU), a memory 504, e.g., random access memory (RAM) and/or read only memory (ROM), a module 505 for providing forwarding of fax calls to a unified messaging service, and various input/output devices 506 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 505 for providing forwarding of fax calls to a unified messaging service can be loaded into memory 504 and executed by processor 502 to implement the functions as discussed above. As such, the present method 505 for providing forwarding of fax calls to a unified messaging service (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for forwarding a fax call, comprising:
receiving a call;
ringing one or more endpoint devices;
detecting an off-hook condition for said one or more endpoint devices;
detecting a fax tone in said call; and
informing a network to forward said call towards a messaging service.

2. The method of claim 1, wherein said informing said network comprises sending at least one of: a Re-INVITE message or a Notify message.

3. The method of claim 2, wherein said Re-INVITE message or said Notify message is directed towards a calling party's gateway.

4. The method of claim 2, wherein said Re-INVITE message or said Notify message is in accordance with a T.38 standard protocol.

5. The method of claim 2, wherein said Re-INVITE message or said Notify message is in accordance with a Session Initiation Protocol (SIP).

6. The method of claim 1, wherein said detecting said fax tone comprises:
providing a delay for call termination.

7. The method of claim 6, wherein said delay is configured by a service provider or a customer.

8. The method of claim 1, wherein said detecting said fax tone is performed only upon receipt of a custom header.

9. The method of claim 1, further comprising:
receiving input from a customer, wherein said input is used to configure one or more parameters controlling how said network will forward said call.

10. A computer-readable medium having stored thereon a plurality of instructions, the plurality of instructions including instructions which, when executed by a processor, cause the processor to perform the steps of a method for forwarding a fax call, comprising:
receiving a call;
ringing one or more endpoint devices;
detecting an off-hook condition for said one or more endpoint devices;
detecting a fax tone in said call; and
informing a network to forward said call towards a messaging service.

11. The computer-readable medium of claim 10, wherein said informing said network comprises sending at least one of: a Re-INVITE message or a Notify message.

12. The computer-readable medium of claim 11, wherein said Re-INVITE message or said Notify message is directed towards a calling party's gateway.

13. The computer-readable medium of claim 11, wherein said Re-INVITE message or said Notify message is in accordance with a T.38 standard protocol.

14. The computer-readable medium of claim 11, wherein said Re-INVITE message or said Notify message is in accordance with a Session Initiation Protocol (SIP).

15. The computer-readable medium of claim 10, wherein said detecting said fax tone comprises:
providing a delay for call termination.

16. The computer-readable medium of claim 15, wherein said delay is configured by a service provider or a customer.

17. The computer-readable medium of claim 10, wherein said detecting said fax tone is performed only upon receipt of a custom header.

18. The computer-readable medium of claim 10, further comprising:
receiving input from a customer, wherein said input is used to configure one or more parameters controlling how said network will forward said call.

19. An apparatus for forwarding a fax call, comprising:
means for receiving a call;
means for ringing one or more endpoint devices;
means for detecting an off-hook condition for said one or more endpoint devices;
means for detecting a fax tone in said call; and
means for informing a network to forward said call towards a messaging service.

20. The apparatus of claim 19, wherein said means for informing said network sends at least one: a Re-INVITE message or a Notify message.
